(19) United States
(12) Patent Application Publication
(10) Pub. No.: US 2017/0301007 A1
(43) Pub. Date: Oct. 19, 2017

(54) STORE TERMINAL AND METHOD PERFORMED BY STORE TERMINAL

(71) Applicant: Woowa Brothers Co., Ltd., Seoul (KR)

(72) Inventors: Ki Hyeok KIM, Seongnam-si (KR); Eun Ji CHO, Namyangju-si (KR); Jeong Bin PARK, Namyangju-si (KR); Hye Mi LEE, Seoul (KR); Young il CHO, Seoul (KR); Hyun Jun YOON, Seongnam-si (KR); Kyo Nam KOO, Namyanngju-si (KR)

(21) Appl. No.: 15/515,943

(22) PCT Filed: Sep. 23, 2015
(86) PCT No.: PCT/KR2015/009989

§ 371 Date: Mar. 30, 2017

(30) Foreign Application Priority Data
Sep. 30, 2014 (KR) 10-2014-0131659

(51) Int. Cl. G06Q 30/06; G06Q 20/34; G06Q 20/20

(52) U.S. Cl. CPC G06Q 30/0637; G06Q 20/20; G06Q 20/34

(57) ABSTRACT

A store terminal including a reception module configured to receive an order from an order relay system, the order relay system being configured to take the order requested by a user terminal and relay the order to the store terminal, and an output module configured to output the order externally.

### CROSS-REFERENCE TO RELATED APPLICATION

This application is a National Stage Entry of International Application No. PCT/KR2015/009989, filed on Sep. 23, 2015, and claims priority from and the benefit of Korean Patent Application No. 10-2014-0131659, filed on Sep. 30, 2014, which is hereby incorporated by reference for all purposes as if fully set forth herein.

### BACKGROUND

### FIELD

The present invention relates to a store terminal and a method performed by the store terminal and, more particularly, to a store terminal which may be used in a store by which an order is received and a delivery service is provided and a method performed by the store terminal.

### DISCUSSION OF THE BACKGROUND

In general, in order to order a delivery product, such as delivery food, a process of checking a list of orderable products through a leaflet or website provided by a corresponding enterprise, selecting one of the products, and making an order for the product to the corresponding enterprise by making a call to the corresponding enterprise is performed.

However, selecting required products from multiple delivery enterprises one-by-one through the above process needs much time and trouble. Recently, there is emerging an order relay service for entering into a member relation with a plurality of delivery enterprises, manifestly arranging a plurality of menus provided by the delivery enterprises for each enterprise, and providing the plurality of menus. Some delivery relay services are providing an application for allowing a user to select a menu and to request an order for the selected menu.

Meanwhile, a member store (that is, delivery store) that has entered into a member relation with the order relay service has to be equipped with a terminal capable of receiving an order that is received by the enterprise of the order relay service from a user and that is relayed to the member store. In a conventional technology, a telephone played such a role. That is, when an order is received from an orderer, a relay enterprise that provides a conventional order relay service uses a method for instructing a product requested by the orderer to be delivered by directly making a call to a store corresponding to the order. Member stores of such conventional order relay service receive orders relayed through calls.

Recently, however, there has emerged a method for relaying an order by connecting the order relay service side and a delivery enterprise over a wired/wireless communication network other than a telephone network. In such method, the delivery enterprise has to be equipped with a separate dedicated terminal capable of wired/wireless is communication other than a telephone.

### SUMMARY

An object of the present invention is to provide a terminal which may be used on the store side that finally accepts an order.

In accordance with an aspect of the present invention, there is provided a store terminal, including a reception module which receives an order from an order relay system which takes the order requested by a user terminal and relays the order to the store terminal and an output module which outputs the order externally.

In accordance with an embodiment of the present invention, the output module outputs the order in an order pad form.

In accordance with an embodiment of the present invention, the store terminal further comprises a response module which receives a response to the order and transmits the received response to the order relay system, wherein the response to the order comprises at least one of order approval and order disapproval, and the response module further receives an expected delivery completion time for the order and transmits the expected delivery completion time to the order relay system if the response to the order is the order approval, and further receives a reason of the order disapproval for the order and transmits the reason to the order relay system if the response to the order is the order disapproval.

In accordance with an embodiment of the present invention, the store terminal further comprises a check module which checks any one of whether a phone call made to a telephone connected to the store terminal is successful or not and whether a user input to a specific input device provided in the store terminal is present or not and a determination module is which determines whether a store corresponding to the store terminal is an order receipt-impossible state based on at least one of whether a phone call is successful or not and whether a user input is present or not, which have been checked by the check module.

In accordance with an embodiment of the present invention, the determination module determines the store to be an order receipt-impossible state if a phone call successful for a specific determination period is not present and a user input has not been inputted to the input device.

In accordance with an embodiment of the present invention, the store terminal further comprises a control module which performs control so that an order for the store is not taken by the order relay system if the determination module determines the store to be the order receipt-impossible state.

In accordance with an embodiment of the present invention, the user terminal displays an order UI comprising information about a member store of the order relay system and requests an order from the order relay system through the order UI, and in order for an order for the store to be not taken by the order relay system, the control module does not include the store information in the order UI displayed on the user terminal or deactivates an item regarding the store so that the store is not selected in the order UI.

In accordance with an embodiment of the present invention, the store terminal further comprises a credit card terminal module which performs a credit card query or credit card settlement function.

In accordance with an embodiment of the present invention, the credit card terminal module receives a selection command for selecting any one of the store and an enterprise corresponding to the order relay system, and performs the credit card query or credit is card settlement function in the name of the store or an enterprise corresponding to the order relay system based on the selection command.

In accordance with an another aspect of the present invention, there is provided a store terminal, comprising a check module which checks any one of whether a phone call made to a telephone connected to the store terminal is successful or not and whether a user input to a specific input device provided in the store terminal is present or not, and a determination module which determines whether a store corresponding to the store terminal is an order receipt-impossible state based on at least one of whether a phone call is successful or not and whether a user input is present or not, which have been checked by the check module.

In accordance with another aspect of the present invention, there is provided a method performed by a store terminal, comprising steps of receiving an order from an order relay system which takes the order requested by a user terminal and relays the order to the store terminal, and outputting the order externally.

In accordance with an embodiment of the present invention, the method further comprises a response step of receiving a response to the order and transmitting the received response to the order relay system, wherein the response to the order comprises at least one of order approval and order disapproval, and the response step comprises steps of further receiving an expected delivery completion time for the order and transmitting the expected delivery completion time to the order relay system if the response to the order is the order approval, and further receiving a reason of the order disapproval for the order and transmitting the reason to the order relay system if the response to the order is the order disapproval.

In accordance with an embodiment of the present invention, the method further comprises steps of receiving a selection command for selecting any one of the store and an enterprise corresponding to the order relay system, and performing a credit card query or credit card settlement function in a name of the store or an enterprise corresponding to the order relay system based on the selection command.

In accordance with another aspect of the present invention, there is provided a method performed by a store terminal, including the steps of checking any one of whether a phone call made to a telephone connected to the store terminal is successful or not and whether a user input to a specific input device provided in the store terminal is present or not and determining whether a store corresponding to the store terminal is an order receipt-impossible state based on at least one of whether a phone call is successful or not and whether a user input is present or not, which have been checked by a check module.

In accordance with another aspect of the present invention, there is provided a computer-readable recording medium on which a program for performing the method has been recorded.

In accordance with another aspect of the present invention, there is provided a store terminal, including a processor and memory storing a computer program executed by the processor, wherein the computer program enables the store terminal to perform the method when the computer program is executed by the processor.

The store terminal according to an embodiment of the present invention can accept an order relayed by an order relay system and can process a series of processes that respond to the order.

Furthermore, the store terminal according to an embodiment of the present invention can prevent a user from unnecessarily requesting an order from a store incapable of delivery by making impossible an order for the store if the store is in the state in which it cannot is process the order.

Meanwhile, the store terminal according to an embodiment of the present invention can perform the credit card settlement function in the name of an order relay system in addition to the name of a store corresponding to a store terminal. Accordingly, there is an advantage in that a user who directly visits a store can be provided with a benefit (for example, a discount or the saving of points) provided upon giving an order through an order relay system although the user pays with a credit card for the order relay system.

### BRIEF DESCRIPTION OF THE DRAWINGS

A simple description of the drawings is provided in order to more sufficiently understand the drawings cited in the detailed description of the present invention.

FIG. 1 is a diagram for illustrating an environment in which a store terminal according to an embodiment of the present invention operates.

FIG. 2 is a diagram showing an external configuration of the store terminal according to an embodiment of the present invention.

FIG. 3 is a block diagram showing a schematic configuration of the store terminal according to an embodiment of the present invention.

FIG. 4 is a flowchart for illustrating the order processing function of the store terminal according to an embodiment of the present invention.

FIG. 5a is a flowchart for illustrating the store state check function of the store terminal according to an embodiment of the present invention.

FIG. 5b is a diagram for illustrating an example of a method for controlling, by the store terminal according to an embodiment of the present invention, a user terminal so that is the user terminal does not request an order from a store.

FIG. 6 is a flowchart for illustrating a credit card settlement function according to an embodiment of the present invention.

### DETAILED DESCRIPTION OF THE ILLUSTRATED EMBODIMENTS

The present invention may be modified in various ways and may have some embodiments. Specific embodiments are to be illustrated in the drawings and are to be described the detailed description. It is however to be understood that the present invention is not intended to be limited to the specific embodiments of the present invention, but that the specific embodiments include all of modifications, equivalents and/or substitutions which fall within the spirit and technological scope of the present invention. In describing the present invention, a detailed description of the known technologies will be omitted if it is deemed to make the gist of the present invention unnecessarily vague.

Terms, such as the first and the second, may be used to describe various elements, but the elements should not be restricted by the terms. The terms are used to only distinguish one element from the other element.

The terms used in this application are used to only describe specific embodiments and are not intended to restrict the present invention. An expression of the singular number includes an expression of the plural number unless clearly defined otherwise in the context.

In this specification, terms, such as “comprise (or include)” or “have”, are intended to designate that characteristics, numbers, steps, operations, elements, or parts which are described in the specification, or a combination of them exist, and should not be understood that they exclude the existence or possible addition of one or more other characteristics, numbers, steps, operations, elements, parts, or combinations of them in advance.

Furthermore, in this specification, if any one element “transmits” data to the other element, this means that the element may directly transmit the data to the other element or may transmit the data to the other element through at least another element. In contrast, if any one element “directly transmits” data to the other element, this means that the data is transmitted from the element to the other element without the intervention of another element.

Hereinafter, the present invention is described in detail based on embodiments of the present invention with reference to the accompanying drawings. The same reference numerals proposed in the drawings denote the same member.

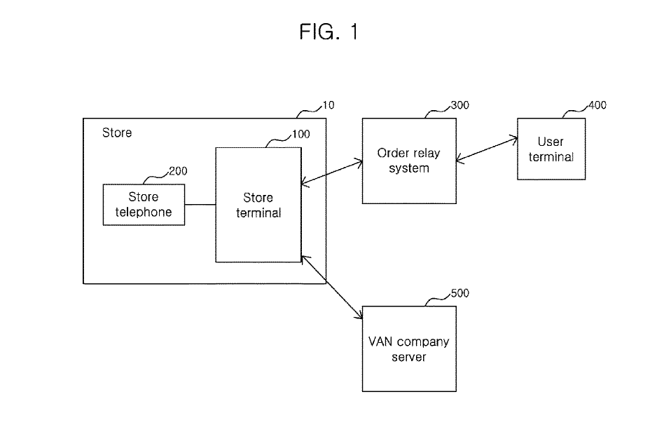

FIG. 1 is a diagram for illustrating an environment in which a store terminal according to an embodiment of the present invention operates.

As shown in FIG. 1, a store 10 may be equipped with the store terminal 100 according to the technical spirit of the present invention.

The store 10 may be further equipped with a store telephone 200 for receiving an order call. Meanwhile, the store terminal 100 may be connected to the store telephone 200, and may check the state of the store 10 by determining whether a call by the store telephone 200 is successful or not as will be described later.

Meanwhile, the store terminal 100 may take an order from a specific order relay system 300.

The store with which the store terminal 100 may be equipped may be a delivery store for directly performing the delivery of a product, but is not limited thereto. The store may be an enterprise which provides a product in a deliverable form. In this case, the delivery task of a product may be performed by a separate delivery enterprise. Meanwhile, in such a case, the is order may be a request that the product should be delivered.

Meanwhile, the store may be a store of a form in which an orderer directly receives a product. In this case, the order may be a request that a product should be prepared so that the product can be picked up.

As shown in FIG. 1, the order relay system 300 may be connected to a user terminal 400 and the store terminal 100 over a wired/wireless network, and may transmit and receive a variety of types of data and/or information necessary to implement the technical spirit of the present invention.

The order relay system 300 may relay an order. The order relay system 300 may provide information about a plurality of member stores and information about a plurality of products, provided by each of the member stores, to a user terminal (for example, 400) that has accessed the order relay system 300 so that an orderer corresponding to the user terminal 400 can select one of the plurality of member stores and request an order for a product. Accordingly, the order transmitted by the user terminal 400 may include information about the store and product selected by the orderer. Meanwhile, the order relay system 300 that has taken the order from the user terminal 400 may transmit the order to the terminal (for example, 100) of a store corresponding to the order transmitted by the user terminal 400. Furthermore, if the store terminal 100 approves or disapproves the order, the order relay system 300 may notify the orderer terminal 400 that the order has been approved or disapproved.

Meanwhile, the store terminal 100 may include a desktop and a laptop, and may be mobile devices including a portable phone, a smart phone, a tablet PC and a personal digital assistant (PDA), a wireless computing device including another handheld device having a wireless access function or a processing device connected to another wireless modem.

In some embodiments, the store terminal 100 may be a form including a point of sale (POS) terminal. In this case, the store terminal 100 may perform various functions and a credit card query/settlement function together, which are necessary to implement the technical spirit of the present invention. To this end, the store terminal 100 may be connected to a VAN company server 500 over a wired/wireless network, and may transmit a query request and/or a settlement request to the VAN company server 500 and receive a response to the request.

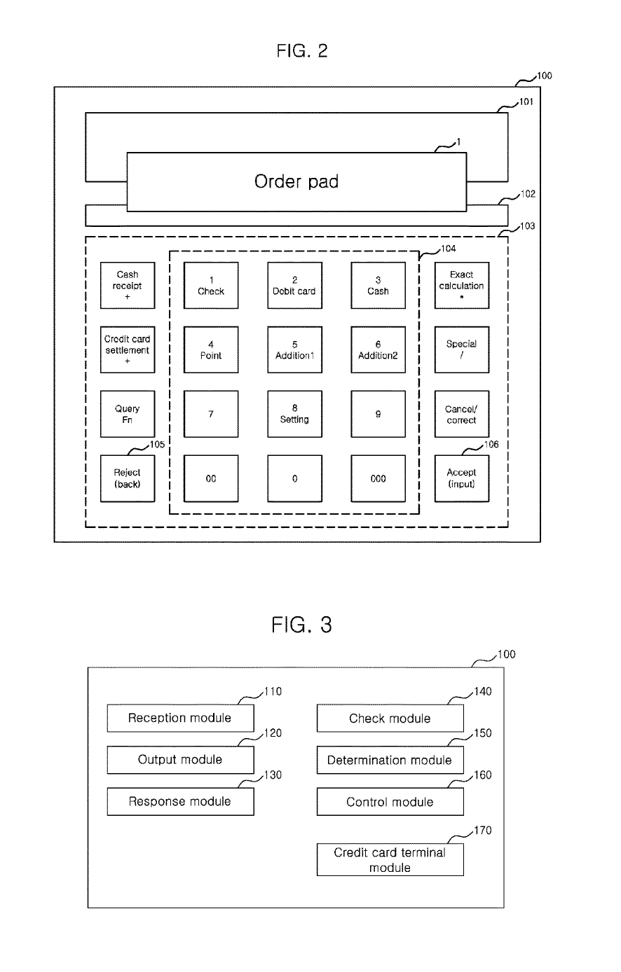

FIG. 2 is a diagram showing an external configuration of the store terminal 100 according to an embodiment of the present invention. Referring to FIG. 2, the store terminal 100 may include a display device 101, a print device 102 and an input device 103.

The display device 101 may be implemented using an LCD, an LED, an OLED, a PDP, electronic paper, a vacuum fluorescent display or a Nixie tube, and may display a variety of types of information.

The print device 102 may be a device capable of printing a variety of types of order pads 1 and receipts on paper.

The input device 103 may be an interface device capable of receiving an input from a user. In FIG. 2, a keypad has been illustrated as being an example of the input device 103, but in some implementation examples, various forms of input modules, such as a keyboard, a mouse and a touch pad, may be included in the store terminal 100.

Meanwhile, the input device 103 may include buttons capable of receiving a variety of types of commands and/or data in addition to a variety of types of number buttons 104, a disapproval button 105 for disapproving a taken order, and an approval button 106 for approving a taken order.

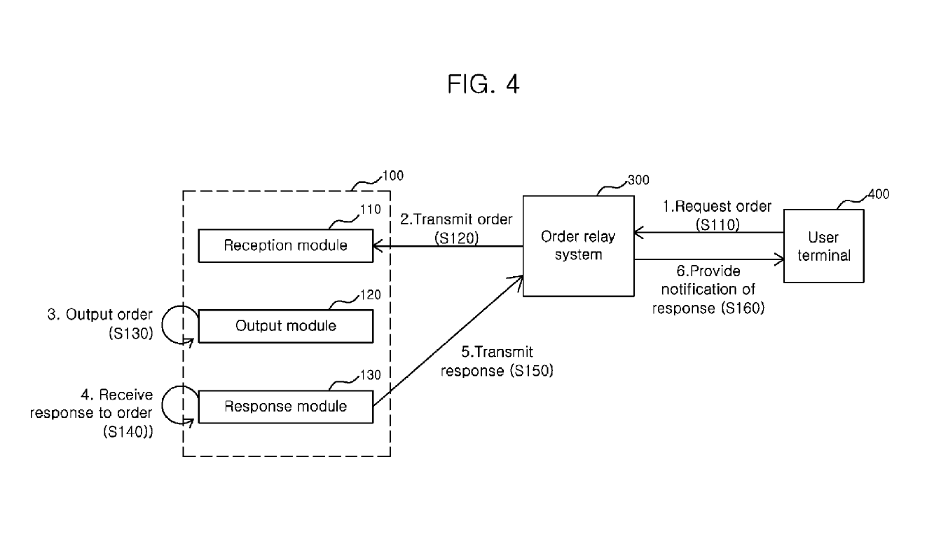

FIG. 3 is a block diagram showing a schematic configuration of the store terminal 100 according to an embodiment of the present invention.

Referring to FIG. 3, the store terminal 100 may include a reception module 110, an output module 120, a response module 130, a check module 140, a determination module 150, a control module 160, and a credit card terminal module 170. In an embodiment of the present invention, some of the elements of FIG. 2 may not correspond to elements that are necessarily required for an implementation of the present invention. Furthermore, in some embodiments, the order relay system 300 may include elements more than the illustrated elements.

The store terminal 100 may include hardware resources and/or software necessary to implement the technical spirit of the present invention, but does not necessarily mean a single physical element or a single device. That is, the store terminal 100 may mean a logical combination of hardware and/or software provided to implement the technical spirit of the present invention. If necessary, the store terminal 100 may be implemented as a set of logical elements for implementing the technical spirit of the present invention in such a manner that the store terminals are installed on separated devices and perform respective functions.

Furthermore, the store terminal 100 may mean a set of elements separately implemented for each function or role for implementing the technical spirit of the present invention. For example, the reception module 110, the output module 120, the response module 130, the check module 140, the determination module 150, the control module 160 and/or the credit card terminal module 170 may be located in different physical devices or may be located in the same physical device.

Furthermore, in some implementation examples, detailed elements that form each of the reception module 110, the output module 120, the response module 130, the check module 140, the determination module 150, the control module 160 and/or the credit card terminal module 170 may be located in different physical devices. The detailed elements located in the different is physical devices may be organically combined to realize a function performed by each of the modules.

Furthermore, in this specification, the module may mean a functional or structural combination of hardware for performing the technical spirit of the present invention and software for driving the hardware. For example, the module may mean a logical unit of specific code and hardware resources on which the specific code is performed. A person who has ordinary skill in the art may easily reason that the module does not necessarily mean pieces of code that are physically connected or one kind of hardware.

The control module 160 may control the functions and/or resources of other elements (for example, the reception module 110, the output module 120, the response module 130, the check module 140, the determination module 150 and/or the credit card terminal module 170) included in the store terminal 100.

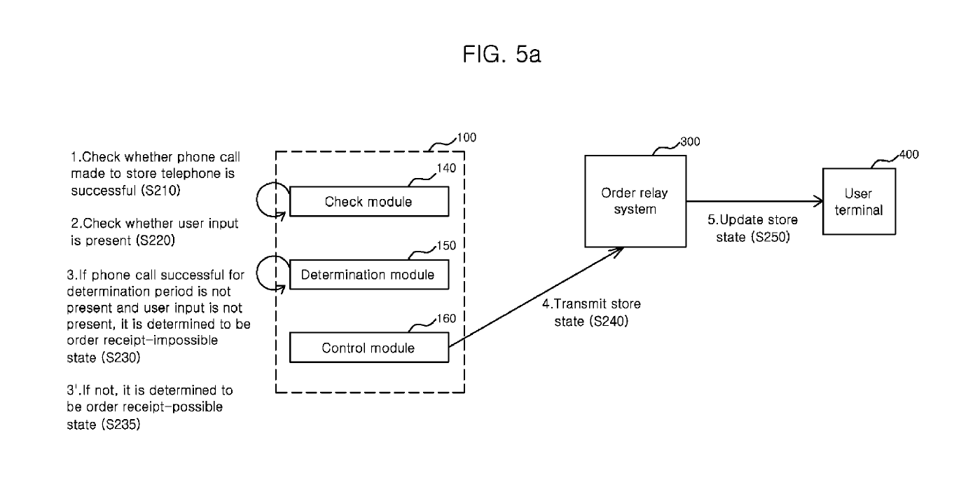

Meanwhile, the store terminal 100 may provide a function for processing an order relayed by the order relay system 300, a function for determining whether the store 10, in which the store terminal 100 is used, is the state in which an order can be now taken, and a credit card query/settlement function. The functions performed by the modules of the store terminal 100 shown in FIG. 3 are described below with reference to FIGS. 4 to 6.

FIG. 4 is a flowchart for illustrating the order processing function of the store terminal 100 according to an embodiment of the present invention.

Referring to FIG. 4, when the user terminal 400 selects any one of the member stores of the order relay system 300 and some of products provided by the selected store, and requests an order from the order relay system 300 (S110), the order relay system 300 may transmit the taken order information to the store terminal 100 of the store corresponding to the order. In response thereto, the reception module 110 may take the order (S120). The order may include information about the store and information about the product, and may further include a variety of types of information (for example, the address of an orderer) necessary for delivery.

Meanwhile, the output module 120 may output the order, taken by the reception module 110, to the outside. In one embodiment, the output module 120 may output the order in the form of an order pad 1 through the print device 102 included in the store terminal 100. However, the present invention is not limited to the form, and the order may be output in any form that may be recognized by the store owner or employee of the store. For example, in an implementation example, the output module 120 may display the order on the display device 101 included in the store terminal 100.

Meanwhile, the response module 130 may receive a response to the order (S140), and may transmit the received response to the order relay system (S150).

The response to the order may include order approval or order disapproval.

For example, a store owner or an employee may input an order approval response by selecting the approval button 106 included in the keypad of the store terminal 100 or may input an order disapproval response by selecting the disapproval button 105 included in the keypad.

The order approval may be a response meaning that the order can be processed, and the order disapproval may be a response meaning that the order cannot be processed. Accordingly, if the response to the order is order approval, the response module 130 may further receive an expected delivery completion time for the order and transmit it to the order relay system 300. Furthermore, if the response to the order is order disapproval, the response module 130 may further receive a reason of order disapproval for the order and transmit it to the order relay system 300.

Meanwhile, the order relay system 300 may notify the user terminal 400 of the order response received from the response module 130 so that a user corresponding to the user terminal 400 can receive feedback for the order.

As described above, in accordance with an embodiment of the present invention, the store terminal 100 may process a series of processes for taking a delivery order relayed by the order relay system 300 and responding to the delivery order.

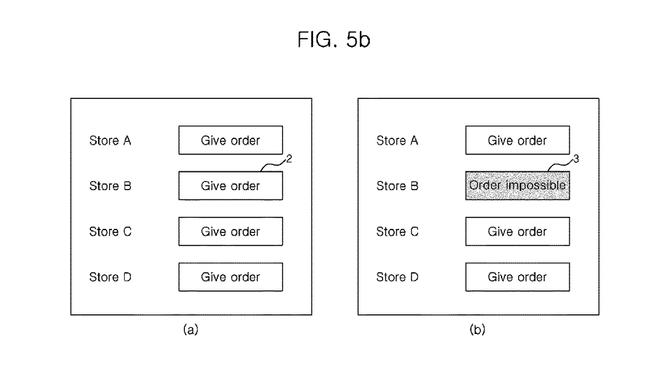

FIG. 5a is a flowchart for illustrating the store state check function of the store terminal 100 according to an embodiment of the present invention.

Referring to FIG. 5a, the check module 140 may check whether a phone call made to the telephone 200 connected to the store terminal 100 is successful or not (S210), and/or may check whether a user input to the input device 103 of the store terminal 100 is present or not (S220).

The check module 140 may check whether a phone call is successful or not and whether a user input is present or not in a specific cycle (for example, every second). Alternatively, the check module 140 may check whether a phone call is successful or not whenever the phone call is made to the telephone 200 or may check a user input whenever the user input is input to the input device 103.

In this case, the phone call has been successful may mean that a phone call made to the telephone 200 is received and the phone call has been connected between a sender and the telephone 200.

Meanwhile, the determination module 150 may determine whether the store 10 is corresponding to the store terminal 100 is an order receipt-impossible state based on at least one of whether a phone call is successful or not and whether a user input is present or not, which have been checked by the check module 140.

For example, as shown in FIG. 5a, if a successful phone call successful has not been present for a specific determination period and a user input has not been inputted to the input device, the determination module 150 may determine that the store 10 is an order receipt-impossible state (S230). If not, that is, if a successful phone call is present for the determination period or a user input is present, the determination module 150 may determine that the store 10 is an order receipt-possible state (S235). The reason for this is that the determination module 150 may consider that there is no person who will process the order in the store 10 if a successful phone call has not been present for the determination period or a user input has not been inputted to the input device.

In some implementation examples, the determination module 150 may determine whether the store 10 corresponding to the store terminal 100 is the order receipt-impossible state based on any one of whether a phone call is successful or not and whether a user input is present or not, which have been checked by the check module 140.

Meanwhile, if the determination module 150 has determined that the store 10 is the order receipt-impossible state, the control module 160 may perform control so that the order for the store is not taken by the order relay system 300.

In one embodiment, the user terminal 400 may display an order user interface (UI) including information about a member store of the order relay system 300, and may request an order from the order relay system through the order UI. In this case, in order for the order for the store to be not taken by the order relay system 300, the control module 160 may not include is the store information in the order UI displayed on the user terminal 400 or may deactivate an item regarding a delivery store so that the delivery store is not selected in the delivery order UI.

FIG. 5b is a diagram for illustrating an example of a method for controlling, by the control module 160, the user terminal 400 so that the user terminal does not request an order from a store. Referring to FIG. 5b, an order UI displayed on the user terminal 400 may include a list of member stores that have joined the order relay system 300 and a UI through which an order can be requested from each of the member stores. If the store 10 is a store B of FIG. 5b and the state of the store B is the order receipt-possible state, the order UI may include a UI 2 (“Give order”) through which an order can be requested from the store B, as shown in (a) of FIG. 5b. If the state of the store B is the order receipt-impossible state, however, the UI 2 through which an order for the store B can be requested may be deactivated, and a UI 3 providing notification that an order for the store B cannot be requested, such as that shown in (b) of FIG. 5b, may be included in the order UI.

In addition, the deactivation of the item regarding the store so that the store is not selected in the order UI may be implemented in various manners. For example, in the order UI, the item regarding a corresponding store may switch to the state (for example, the state in which hyperlink for the order request function has been removed or the state in which the order request function has been deactivated) in which the item cannot be selected (for example, a touch or click).

Meanwhile, the control module 160 may directly control the user terminal 400, but the technical spirit of the present invention is not limited thereto. The control module 160 may indirectly control the user terminal 400 through the order relay system 300.

In one embodiment, as shown in FIG. 5a, the control module 160 may transmit is information about the state (that is, the order receipt-impossible state or the order receipt-possible state) of the store 10 to the order relay system 300 (S240), so the order relay system 300 updates the user terminal 400 that has accessed the order relay system 300 with the state of the store 10 (S250). Accordingly, the user terminal 400 may deactivate the item regarding the store 10 so that information about the store 10 is not included in the order UI or the store 10 is not selected in the order UI.

In accordance with the embodiment of the present invention, if the store 10 is the state in which it cannot process an order, the store terminal 100 makes impossible an order for the store 10. Accordingly, a user may not unnecessarily request an order from a store incapable of taking an order.

Meanwhile, referring back to FIG. 3, the credit card terminal module 170 may perform a credit card query or credit card settlement function so that a store can provide card settlement although it does not include a separate card settlement terminal. That is, the credit card terminal module 170 may request credit card query or credit card settlement from a specific

VAN company server, may receive a response to settlement from the VAN company server, and may output a receipt.

Meanwhile, a common card settlement terminal (not shown) may perform a settlement function in the name (for example, a business registration number) of a store which has purchased or lent the card settlement terminal. That is, the common card settlement terminal may perform a credit card settlement function by which a settlement person pays the price to the store.

However, a member store that has joined the order relay system 300 needs to perform a credit card settlement function in the name of the order relay system 300 in addition to is the name of the member store. For example, although a user who has directly visited the member store pays the price to the order relay system 300 with a credit card, the user may be provided with a benefit (for example, a discount or the saving of points) provided upon taking an order through the order relay system 300.

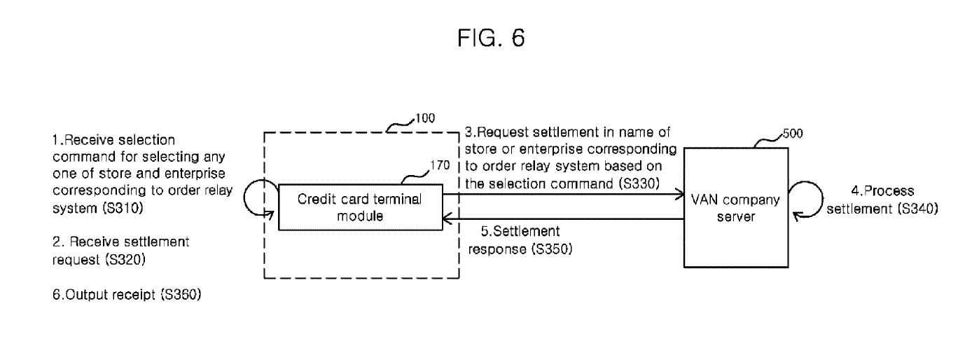

To this end, the store terminal 100 may perform card settlement in the name of the store 10 or may provide a function capable of performing card settlement in the name of a store corresponding to the order relay system 300. This is described below with reference to FIG. 6.

FIG. 6 is a flowchart for illustrating the credit card settlement function of the store terminal 100 according to an embodiment of the present invention.

Referring to FIG. 6, the credit card terminal module 170 may receive a selection command for selecting any one of the store 10 and an enterprise corresponding to the order relay system 300 (S310). Furthermore, the credit card terminal module 170 may receive a credit card settlement request from a settlement person (S320). The enterprise corresponding to the order relay system 300 may be an enterprise which manages or owns the order relay system 300.

Accordingly, the credit card terminal module 170 may perform a credit card query or credit card settlement function in the name of the store 10 or an enterprise corresponding to the order relay system 300 based on the selection command. That is, when a selection command for selecting the store 10 and a credit card settlement request are received, the credit card terminal module 170 may make a settlement request from the VAN company server 500 in the name (for example, a business registration number) of the store 10. When a selection command for selecting an enterprise corresponding to the order relay system 300 and a credit card settlement request are received, the credit card terminal module 170 may make a settlement request from the VAN company server 500 in the name (for example, a business registration is number) of an enterprise corresponding to the order relay system 300 (S330).

Thereafter, the VAN company server 500 may process the credit card settlement (S340) and transmit the results of the settlement processing to the credit card terminal module 170 (S340).

Accordingly, the credit card terminal module 170 may output a receipt (S350).

Meanwhile, in some implementation examples, the store terminal 100 may include a processor and memory for storing a program executed by the processor. The processor may include a single core CPU or a multi-core CPU. The memory may include high-speed random access memory and may include one or more magnetic disk storage devices, flash memory devices or non-volatile memory, such as other non-volatile solid state memory devices. Access to the memory by the processor and another element may be controlled by a memory controller. In this case, if the program is executed by the processor, the order relay system 300 according to the present embodiment may perform a method for providing the order relay system.

Meanwhile, the method performed by the store terminal according to an embodiment of the present invention may be implemented in the form of computer-readable program code and may be stored in a computer-readable recording medium. The computer-readable recording medium includes all of kinds of recording devices in which data readable by a computer system is stored.

The program code recorded on the recording medium may have been specifically designed and configured for the present invention or may have been known and usable by those skilled in the software field.

Examples of the computer-readable recording medium include hardware devices is specially configured to store and execute the program instructions, such as magnetic media including a hard disk, a floppy disk and a magnetic tape, optical media including CD-ROM and DVD, magneto-optical media including a floptical disk, ROM, RAM, and flash memory. Furthermore, the aforementioned medium may be a transmission medium, such as light, a metal line, or a waveguide including a carrier for sending a signal that designates program code, a data structure, etc. Furthermore, the computer-readable recording medium may be distributed over computer systems connected over a network, and the computer-readable code may be stored and executed in a distributed manner.

The program code may include, for example, not only machine code, such as that produced by a compiler, but also high-level language code executable by a device for electronically processing information using an interpreter, for example, a computer.

The aforementioned hardware device may be configured to operate as one or more software module in order to perform the operation of the present invention, and vice versa.

The aforementioned description is illustrative, and those skilled in the art to which the present invention pertains will appreciate that the present invention may be implemented in other detailed forms without departing from the technological spirit or essential characteristics of the present invention.

Accordingly, the aforementioned embodiments should be construed as being only illustrative not as being restrictive from all aspects. For example, each of the elements described in the singular form may be distributed and implemented. Likewise, the elements that have been illustrated as being distributed may also be implemented in a combined form.

The range of right of the present invention is defined by the appended claims rather than the detailed description, and the present invention should be construed as covering all is modifications or variations derived from the meaning and scope of the appended claims and their equivalents.

The present invention may be used in a store terminal and a method performed by a store terminal.

1. A store terminal, comprising:
a reception module configured to receive an order from an order relay system, the order relay system being configured to take the order requested by a user terminal and relay the order to the store terminal; and
an output module configured to output the order externally.

2. The store terminal of claim 1, wherein the output module is configured to output the order in an order pad form.

3. The store terminal of claim 1, further comprising a response module configured to receive a response to the order and transmit the received response to the order relay system,
wherein:
the response to the order comprises at least one of order approval and order disapproval;
the response module is further configured to receive an expected delivery completion time for the order and transmit the expected delivery completion time to the order relay system if the response to the order is the order approval; and
the response module is further configured to receive a reason of the order disapproval for the order and transmit the reason to the order relay system if the response to the order is the order disapproval.

4. The store terminal of claim 1, further comprising:
a check module configured to check any one of whether a phone call made to a telephone connected to the store terminal is successful and whether a user input to a specific input device provided in the store terminal is present; and
a determination module configured to determine whether a store corresponding to the store terminal is an order receipt-impossible state based on at least one of whether the phone call is successful or not and whether the user input is present, which have been checked by the check module.

5. The store terminal of claim 4, wherein the determination module is configured to determine the store to be the order receipt-impossible state if a phone call successful for a specific determination period is not present and a user input has not been inputted to the input device.

6. The store terminal of claim 4, further comprising a control module configured to perform a control so that an order for the store is not taken by the order relay system if the determination module determines that the store is in the order receipt-impossible state.

7. The store terminal of claim 6, wherein:
the user terminal is configured to display an order user interface (UI) comprising information about member stores of the order relay system and request an order to the order relay system through the order UI, and
in order for an order for the store to be not taken by the order relay system, the control module is configured to not include the store information in the order UI displayed on the user terminal or deactivate an item regarding the store so that the store is not selected in the order UI.

8. The store terminal of claim 1, further comprising a credit card terminal module configured to perform a credit card query or credit card settlement function.

9. The store terminal of claim 8, wherein the credit card terminal module is configured to:
receive a selection command for selecting any one of the store and an enterprise corresponding to the order relay system and
perform the credit card query or credit card settlement function in the name of the store or an enterprise corresponding to the order relay system based on the selection command.

10. A store terminal, comprising:
a check module configured to check any one of whether a phone call made to a telephone connected to the store terminal is successful and whether a user input to a specific input device provided in the store terminal is present; and
a determination module configured to determine whether a store corresponding to the store terminal is an order receipt-impossible state based on at least one of whether the phone call is successful and whether the user input is present or not, which have been checked by the check module.

11. A method performed by a store terminal, comprising steps of:
receiving an order from an order relay system that takes the order requested by a user terminal and relays the order to the store terminal; and
outputting the order externally.

12. The method of claim 11, further comprising a response step of receiving a response to the order and transmitting the received response to the order relay system, wherein the response to the order comprises at least one of order approval and order disapproval,
wherein the response step comprises steps of:
further receiving an expected delivery completion time for the order and transmitting the expected delivery completion time to the order relay system if the response to the order is the order approval; and
further receiving a reason of the order disapproval for the order and transmitting the reason to the order relay system if the response to the order is the order disapproval.

13. The method of claim 11, further comprising steps of:
receiving a selection command for selecting any one of the store and an enterprise corresponding to the order relay system; and
performing a credit card query or credit card settlement function in a name of the store or an enterprise corresponding to the order relay system based on the selection command.

14. A method performed by a store terminal, comprising steps of:
checking any one of whether a phone call made to a telephone connected to the store terminal is successful and whether a user input to a specific input device provided in the store terminal is present; and
determining whether a store corresponding to the store terminal is an order receipt-impossible state based on at least one of whether the phone call is successful and whether the user input is present, which have been checked by a check module.

15. A computer-readable recording medium on which a program for performing a method according to claim 11 has been recorded.

16. A store terminal, comprising:
a processor; and
memory storing a computer program executed by the processor,
wherein the computer program enables the store terminal to perform a method according to claim 11 when the computer program is executed by the processor.

17. A computer-readable recording medium on which a program for performing a method according to claim 14 has been recorded.

18. A store terminal, comprising:
a processor; and
memory storing a computer program executed by the processor,
wherein the computer program enables the store terminal to perform a method according to claim 14 when the computer program is executed by the processor.
